(19) United States
(12) Patent Application Publication
(10) Pub. No.: US 2026/0317880 A1
(43) Pub. Date: Oct. 15, 2026

(54) METHOD FOR PRODUCING OR REPAIRING A WORKING ROLL, ROLL STAND, METAL STRIP AND APPLICATION DEVICE FOR APPLYING PARTICLES

(71) Applicant: SMS group GmbH, Mönchengladbach (DE)

(72) Inventors: Roland MÜLLER-JENA, Düsseldorf (DE); Thomas WIRTZ, Elsdorf (DE); Andreas FÜRST-PITZ, Willich (DE); Walter WENGENROTH, Düsseldorf (DE); Matthias VOGD, Düsseldorf (DE); Ingo GRAMS, Solingen (DE)

(73) Assignee: SMS group GmbH, Mönchengladbach (DE)

(21) Appl. No.: 19/485,569

(22) PCT Filed: May 17, 2024
(86) PCT No.: PCT/EP2024/063709

§ 371 Date: Nov. 18, 2025

(30) Foreign Application Priority Data
May 19, 2023 (DE) 10 2023 113 187.7

(51) Int. Cl. C23C 4/12; C23C 4/067

(52) U.S. Cl. CPC C23C 4/12; C23C 4/067

(57) ABSTRACT

The invention relates to a method for producing or repairing a working roll which has a main part and a wear protection layer, wherein particles are thermally applied onto the working roll. The method is characterized in that during the thermal application of the particles, 50% or more of the particles, preferably 60% or 75% or more, in particular 80% or more of the particles, remain on the main part and/or on an already applied wear protection layer adhered to the main part and/or on the wear protection layer.

The invention relates to a method for producing or repairing a working roll having a main part and a wear protection layer, in which method a coating material having particles is thermally applied to the main part.

The invention further relates to a working roll having a main part and a wear protection layer for rolling a metal material.

The invention also relates to a roll stand for processing a metal product, such as a metal strip.

The invention further relates to a metal strip.

The invention further relates to an application device for applying particles to a main part of a working roll, having a burner device and an open-loop and/or closed-loop control device for providing open-loop and/or closed-loop control of the application device.

Generic methods for producing or repairing a working roll are known from the prior art.

The object of the invention is that of providing an improvement over or an alternative to the prior art.

The object of the invention is achieved according to a first aspect by a method for producing or repairing a working roll having a main part and a wear protection layer, in which a coating material having particles is thermally applied to the working roll, wherein the method is characterized in that during the thermal application of the particles, 50% or more of the particles, preferably 60% or 75% or more, in particular 80% or more of the particles, remain on the main part and/or on an already applied wear protection layer adhered to the main part and/or on the wear protection layer.

Because the present method succeeds in ensuring that at least approximately 50% of the particles adhere to the main part or the wear protection layer thereof and are not lost, the present method for producing or repairing a working roll or a wear protection layer therefor can be carried out particularly efficiently, in particular in a particularly resource-saving manner.

Previous production methods for generic working rolls involve enormous losses of particles of approximately 50% and often more, since the particles in question often adhere only insufficiently when they hit the surface of the working roll and are therefore lost and/or do not reach the surface of the working roll during the coating process but miss the component, in particular due to interaction with the air flow surrounding the surface of the working roll, in particular due to interaction with local turbulence on the path of the particles from the outlet nozzle of the burner device towards the surface of the working roll.

A non-adherent particle mixture can hardly be reused due to its complex structure, especially in combination with processing by a thermal application process, since reuse would require the particle mixture to be separated into pure substances again and/or the pure substances to be re-granulated.

The previous disadvantages of the prior art can be significantly reduced or even completely avoided with the present invention.

In particular, the application efficiency can also be determined by the choice of the application device or its process burner.

The present production or repair method is a thermal application method, more precisely a thermal spraying method for the thermal spraying of particles onto a main part and/or an already existing wear protection layer of a working roll for rolling of a metal product, such as a metal strip.

It should firstly be pointed out here that, in the context of this patent application, indefinite articles and indefinite numerical indications such as “one . . . ,” “two . . . ,” etc., are as a rule to be understood as “at least” indications, i.e., as “at least one . . . ,” “at least two . . . ,” etc., unless it is clear from the context or the specific text of a particular passage that only “exactly one . . . ,” “exactly two . . . ” etc., is meant.

It should also be noted at this point that, in the context of the present patent application, the term “in particular” should always be understood as introducing an optional, preferred feature. The expression should not be understood to mean “specifically” or “namely.”

The particles can be designed in different ways within the meaning of the invention, but preferably as ceramic particles and/or as metal particles. If necessary, further particles may also be provided as functional, auxiliary or filler materials or the like.

The particles or a mixture of particles can provide the starting material for the production of the wear protection layer in powder form.

In this respect, the particles or the particle mixture can be prepared as a powder and accordingly provided or processed in powder form on the application device.

According to a first variant of particles provided in powder form, particles can also be provided in a suspension as starting material for the production of the wear protection layer.

A suspension has particles that are dispersed in a liquid phase. The liquid phase may comprise water and/or ethanol and/or isopropanol and/or the like. In particular, liquid phases with a low enthalpy of vaporization can be used, in particular with an enthalpy of vaporization of less than or equal to 2.5 kJ/g.

Furthermore, the suspension may contain a dispersant, in particular citric acid, HNO₃, diammonium citrate, C₅H₈O₂ or the like.

The suspension is partially evaporated under the influence of the thermal energy of a hot gas stream generated by the burner device, wherein the suspension is usually partially evaporated before the suspension comes into contact with the main part and/or the wear protection layer, i.e., in particular before the thermal application of the particles thus obtained, wherein the particles do not evaporate, but the liquid phase and/or the dispersant. In this respect, particles or the particle mixture can also be provided as a suspension at the burner device within the scope of this description.

It has been shown that using a suspension, a wear protection layer with a low roughness value and/or low porosity and/or a particularly high hardness can be produced.

According to a second variant of particles provided in powder form, particles can also be provided in wire-shaped and/or rod-shaped form as starting material for the production of the wear protection layer. Corresponding wires (cored wires) or rods (cored rods) for providing the particles can have a sheath and particles enclosed by the sheath.

When thermally applying the wear protection layer using a wire or a rod as the starting material for the particles, the starting material can be melted by the hot gas stream provided by the burner device and/or melted when a plasma is generated between an anode and a cathode. As a rule, this takes place before the particles obtained in this way come into contact with the main part and/or the wear protection layer, i.e., in particular before the thermal application of the particles obtained in this way. In this respect, particles or the particle mixture can also be provided as a wire and/or as a rod on the burner device within the scope of this description.

Suitable particles can be formed as a hard phase or hard phase particles and/or as a matrix or matrix particles.

In the sense of the invention, the term “hard phase” describes harder particles which are embedded in the softer matrix on the wear protection layer, wherein the softer matrix is created using matrix particles during thermal spraying.

Hard phases suitable for the wear protection layer can in particular be oxidic, carbide or boride hard phases, which advantageously have a high hardness. For example, a compound of silicon and carbon can be used, which forms silicon carbide (SiC).

The term “matrix” accordingly describes a structure on the wear protection layer that carries the hard phase. In this respect, the hard phase is embedded in the matrix.

Both the hard phase and the matrix can be provided by appropriate particles in the powdered starting material.

Particularly preferably, the hard phase particles have a proportion of tungsten carbide (WC) of greater than or equal to 50 wt. %, preferably a proportion of greater than or equal to 60 wt. % and particularly preferably of greater than or equal to 70 wt. %.

In the context of this application, tungsten carbide (WC) is explicitly understood to mean mono-tungsten carbide (WC).

By including a weight proportion of tungsten carbide in the wear protection layer, in particular as a component of a hard phase of the wear protection layer, the hardness of the wear protection layer can be advantageously increased, wherein an increased proportion of mono-tungsten carbide (WC) in the wear protection layer further increases the hardness of the wear protection layer.

The wear protection layer can advantageously have a proportion of tungsten carbide (WC) of greater than or equal to 2 wt. %, preferably a proportion of greater than or equal to 20 wt. % and particularly preferably of greater than or equal to 25 wt. % or greater than or equal to 30 wt. %. Furthermore, the wear protection layer can advantageously have a proportion of tungsten carbide (WC) of greater than or equal to 40 wt. %, preferably a proportion of greater than or equal to 45 wt. % and particularly preferably of greater than or equal to 65 wt. % or greater than or equal to 70 wt. %. Particularly advantageously, the wear protection layer can have a proportion of tungsten carbide (WC) of greater than or equal to 75 wt. %, preferably a proportion of greater than or equal to 80 wt. % and particularly preferably of greater than or equal to 85 wt. % or greater than or equal to 87 wt. %.

Preferably, the wear protection layer has at least one, two, three, four, five, six, seven or more of the elements tungsten carbide (WC), aluminum oxide (Al₂O₃), zirconium oxide (ZrO₂), chromium carbide (Cr₃C₂, Cr₇C₃ and/or Cr₂₃C₆), vanadium carbide (VC), silicon carbide (SiC), tungsten boride (WB), chromium oxide (CrO, Cr₂O₃, CrO₂ and/or CrO₃), titanium carbide (TIC), titanium oxide (TiO, Ti₂O₃ and/or TiO₂) or molybdenum carbide (Mo₂C and/or MoC), in particular at least one, two, three, four or more of the elements tungsten carbide (WC), aluminum oxide (Al₂O₃), zirconium oxide (ZrO₂), chromium carbide (Cr₃C₂, Cr₇C₃ and/or Cr₂₃C₆) and/or vanadium carbide (VC).

The matrix particles comprise iron and/or nickel and/or cobalt and/or molybdenum and/or boron and/or tungsten, wherein the composition of the matrix particles also substantially corresponds to the composition of the matrix of a wear protection layer produced with the matrix particles.

By using iron as a component of the wear protection layer matrix produced by the matrix particles, a comparatively cost-effective wear protection layer matrix can be achieved. This can be particularly advantageous if a working roll's wear protection layer wears out faster than it corrodes.

By using nickel as a component of the matrix particles and thus also of the matrix of the wear protection layer, the chemical resistance of the matrix of the wear protection layer can be improved. Depending on the alloy of the wear protection layer, a nickel-containing matrix can be used to ensure that the wear protection layer is chemically resistant overall, in particular corrosion-resistant.

Cobalt as a component of the matrix particles and thus also of the matrix of the wear protection layer can lead to an increase in the temperature resistance of the wear protection layer. Cobalt can also advantageously increase the hardness of the matrix and thus of the entire wear protection layer.

By using molybdenum as a component of the matrix particles and thus also of the matrix of the wear protection layer, the chemical resistance and/or the temperature resistance of the wear protection layer, in particular of the matrix, can be improved.

It can also be advantageous for the temperature resistance of the matrix and thus also of the entire wear protection layer if the matrix contains tungsten, so that tungsten is advantageous as a component of the matrix particles.

It has been shown that the adhesion properties of the matrix and thus also of the wear protection layer as such can be improved by boron as a matrix component, so that boron is advantageous as a component of the matrix particles.

Furthermore, the matrix particles and thus also the matrix of the wear protection layer can also contain manganese, copper, chromium and/or silicon, whereby the matrix of the wear protection layer can be further optimized with regard to its ductility, hardness, chemical resistance, machinability, friction properties, temperature resistance, adhesion resistance and/or the like.

It is advantageous if, during the thermal application of the particles, 50% or less of the particles, preferably 40% or less, or 25% or less, particularly preferably 20% or less, rebound from the main part and/or from an already applied wear protection layer.

This can ensure an advantageous increase in efficiency with regard to the present method.

A suitable adhesion of particles to the working roll in the sense of the invention can be achieved simply by a particle mixture having hard phase particles and matrix particles has a residual moisture of less than or equal to 10%, preferably less than or equal to 5%, particularly preferably less than or equal to 2%.

For the purposes of the invention, the term “residual moisture” is to be understood as the amount of moisture, in particular water, which is bound in the particle mixture present.

The residual moisture is measured here before adding the particles or the particle mixture into a hot gas stream of an application device.

If the residual moisture is in a range above the above-mentioned values, it is advantageous if the residual moisture is reduced to a value of less than or equal to 10%, preferably less than or equal to 5% and particularly preferably less than or equal to 2%, before the particles are added to the hot gas stream.

In this respect, it is advantageous if the present method, in particular other method parameters, are manipulated depending on the residual moisture of the particle mixture.

For example, the exit temperature of a hot gas stream, which exits together with the particles from an outlet nozzle of an application device, can be manipulated depending on the residual moisture, to name just one example.

Furthermore, a lower residual moisture can lead to a more homogeneous particle mixture, in particular with regard to the distribution of the moisture in the particle mixture, whereby an improvement in the adhesion of the particles to the main part and/or the wear protection layer can be achieved.

In this respect, the residual moisture can ensure an advantageous increase in efficiency with regard to the present method.

An advantageous adhesion of particles to the working roll in the sense of the invention can also be achieved or cumulatively improved if the particles have a particle size of greater than or equal to 0.5 μm, preferably greater than or equal to 1 μm, and/or a particle size of less than or equal to 60 μm, preferably less than or equal to 30 μm and particularly preferably less than or equal to 15 μm.

The term “particle size” in the sense of the invention refers to the average powder diameter of a powder consisting of particles which provides the starting material for the wear protection layer.

For example, the smaller the particle size or the average powder diameter, the smaller the exit speed (particle speed) of the hot gas stream at the exit nozzle of the application device can generally be selected. On the other hand, smaller particle sizes can be used to manipulate the level of exit temperatures at an outlet nozzle of an application device.

This can also influence the application efficiency, as it has been found that smaller particles improve the average adhesion or adhesion capacity of the particles to the application roll (while maintaining the same heat transfer).

In this respect, the degree of adhesion of particles to the working roll can be influenced simply by selecting the particle size.

In this respect, the powder size can ensure an advantageous increase in efficiency with regard to the present method.

Further advantageous interactions that are likely to result from the particle size can be found in the table below.

TABLE 1
Particle size of the powdered particle mixture (μm): Roughness of the wear protection layer, roughness of a product (strip)
machined with the working roll, residual stresses in the wear protection layer and/or the main part, porosity, hardness, number
of peaks, homogeneity, in particular homogeneity of the distribution of the coating elements within the wear protection layer
as well as homogeneity of the thickness of the wear protection layer, (coating) element distribution, adhesive tensile strength,
delamination resistance and scatter (evaluation in each case between 0 and 10 with the individual scales between smallest possible
(0) and largest possible (10) (scale designation: k-g) as well as neutral (0) and best possible (10) (scale designation: n-b).)

| | | | | | | Peak | | | | | |
|---|---|---|---|---|---|---|---|---|---|---|---|
| | Roughness | Roughness | | | | number | | | | | |
| | of wear | of a rolled | | | | of wear | | Element | Adhesive | | |
| Particle | protection | product | Residual | | | protection | Homogeneity | distribution | tensile | Delamination | |
| size | layer | (strip) | stresses | Porosity | Hardness | layer | (thickness) | (homogeneity) | strength | resistance | Spread |
| (μm) | (k-g) | (k-g) | (n-b) | (k-g) | (n-b) | (k-g) | (n-b) | (n-b) | (n-b) | (n-b) | (n-b) |
| 0.5 | 3 | 1 | 8 | 1 | 10 | 10 | 10 | 10 | 7 | 10 | 10 |
| 1 | 4 | 3 | 6 | 1 | 10 | 10 | 10 | 10 | 8 | 10 | 9 |
| 5 | 4 | 5 | 4 | 1 | 10 | 10 | 10 | 10 | 9 | 9 | 8 |
| 10 | 5 | 7 | 4 | 2 | 10 | 9 | 9 | 10 | 10 | 9 | 6 |
| 15 | 7 | 9 | 2 | 3 | 10 | 7 | 8 | 10 | 10 | 9 | 6 |
| 25 | 9 | 10 | 2 | 4 | 8 | 6 | 7 | 8 | 10 | 8 | 2 |
| 30 | 10 | 10 | 1 | 6 | 7 | 5 | 6 | 7 | 9 | 7 | 2 |
| 60 | 10 | 10 | 1 | 8 | 6 | 5 | 4 | 6 | 8 | 7 | 1 |

In order to ensure such advantageous particle sizes on the application device in a reliable manner, it is advantageous if the particles are pre-screened to a particle size of less than or equal to 60 μm, preferably less than or equal to 30 μm, and particularly preferably less than or equal to 15 μm.

By means of the proposed particle size, the scattering range of the powdered particle mixture can also be advantageously influenced, in particular reduced.

More specifically, as the particle size increases, the dispersion width with which the particles hit the working roll can be reduced.

It was shown that with a smaller particle size, a higher (compressive) residual stress level can be achieved in the wear protection layer, which can at least indirectly lead to a beneficial effect with regard to the adhesive tensile strength and/or delamination resistance of the wear protection layer. Furthermore, or depending on the above aspect, a smaller particle size may contribute to a lower porosity of the wear protection layer, whereby the delamination resistance of the wear protection layer may be further improved.

Undesirable impurities can also be removed in advance if the particles or a mixture of particles are pre-screened in accordance with the invention.

Furthermore, the proposed pre-screening can also achieve a higher homogeneity with regard to the powdered particle mixture, which in turn can achieve a correspondingly good homogeneity of the wear protection layer.

Overall, pre-screening can ensure a more stable application process.

For example, in order to be able to provide suitable starting materials for producing different wear protection layers for different working rolls on the application device, it is advantageous if the particles are pre-screened on an application device, in particular before being added to a hot gas stream of the application device.

By pre-screening starting materials or particles for this purpose, parameters of a particle mixture can be adjusted more precisely with the present method.

The adhesion of particles to the working roll in the sense of the invention can also be positively influenced if the particles at or behind an outlet nozzle of an application device have an exit speed of greater than or equal to 500 m/s, preferably greater than or equal to 800 m/s, particularly preferably greater than or equal to 900 m/s, and/or an exit speed of less than or equal to 1500 m/s, preferably less than or equal to 1200 m/s and particularly preferably less than or equal to 1000 m/s.

If the exit speed is selected to be lower, particles may bond less closely with each other, with the main part and/or with the wear protection layer already present on the main part when they impact the working roll, which may, among other things, increase the porosity and/or permeability of the wear protection layer.

If, on the other hand, the exit speed is selected to be higher, the level of residual compressive stresses resulting in the wear protection layer can be increased, which can advantageously increase the adhesive tensile strength of the wear protection layer, but the risk of particles bouncing off into the environment upon impact with the working roll and being lost in the process increases, which can reduce the application efficiency.

In other words, this means that by manipulating the exit speed, the kinetic energy inherent in the particles upon impact with the application roll can also be influenced, which in turn affects the adhesion of particles to the application roll.

For example, a higher exit speed can lead to improved application efficiency of particles on the application roll, because higher kinetic energy generally leads to better adhesion of the particles.

For example, the exit speed also affects the temperature of the particles, since a higher exit speed reduces the contact time with the burner flame, which in turn can reduce the particle temperature at the time of impact on the working roll.

If the exit speed is measured at a location or at a region which is arranged at a distance of 100 mm or less from the exit nozzle, preferably 50 mm or less and particularly preferably 10 mm or less, the exit speed can be measured reproducibly particularly reliably.

For example, this can reduce the risk that the measurement is critically influenced by environmental influences, because falsified measured values can negatively influence the adhesion conditions of particles to the working roll.

For example, the adhesion capacity can also be effectively manipulated by adjusting the exit speed of the hot gas stream depending on the properties of the particles.

In this respect, an adhesion of particles on the working roll in the sense of the invention can also be achieved or cumulatively improved simply by a favorably selected exit speed, as proposed here.

Cumulatively or alternatively, an adhesion capacity of particles on the working roll can also be adjusted if the particles are discharged from an outlet nozzle of an application device by means of a hot gas stream, wherein the particles and/or the hot gas stream have an exit temperature of greater than or equal to 800° C., preferably greater than or equal to 1000° C. and particularly preferably greater than or equal to 1200° C., and/or the particles and/or the hot gas stream have an exit temperature of less than or equal to 2200° C., preferably less than or equal to 2000° C. and particularly preferably less than or equal to 1800° C.

For example, the particles are heated in the hot gas stream and thus also melted or liquefied, wherein the degree of such melt liquefaction is particularly dependent on their particle size.

Overall, this also allows the adhesion capacity of the particles to be adjusted.

The layer quality of the wear protection layer can also be influenced by this.

The exit temperature can be adjusted for example depending on the residual moisture and/or the particle size.

In this respect, it is advantageous if the exit temperature is adjusted depending on properties of the particles.

It may be advantageous to select a higher exit temperature if the residual humidity is higher.

For example, if the particle size is selected to be smaller, the exit temperature can also be set lower.

Particularly meaningful values can be obtained with regard to the exit temperature can be measured if the exit temperature is measured at a location or at a region which is arranged 100 mm or less from the outlet nozzle, preferably 50 mm or less and particularly preferably 10 mm or less.

Experiments have shown that the exit temperature of the particles and/or the hot gas stream can advantageously be measured at a distance of between 5 mm and 15 mm behind the outlet nozzle.

A further very advantageous method variant can be provided if, during the application of particles to the working roll, an overspray surrounding the working roll having at least particles that do not adhere to the main part, process gases, combustion products or the like is sucked off from the environment of the working roll at a suction speed of greater than or equal to 10 m/s, preferably greater than or equal to 15 m/s and particularly preferably greater than or equal to 18 m/s, and/or at a suction speed of less than or equal to 30 m/s, preferably less than or equal to 25 m/s and particularly preferably less than or equal to 20 m/s.

Such extraction can also prevent an unwanted loss of particles.

On the one hand, the amount of overspray critically surrounding the working roll can be advantageously reduced if relevant disruptive elements are removed from the immediate vicinity of the working roll, in particular after contact with the working roll.

Such disruptive elements may include, for example, excess particles, process gases, combustion products or the like, and may lead to quality problems in the wear protection layer due to corresponding contamination or defects if they cannot be adequately removed.

On the other hand, by selecting an extraction speed within the framework of the suggested values, it can be avoided that particles which have not yet had contact with the working roll are adversely deflected from their intended trajectory and thus miss their target on the working roll or only hit the working roll unfavorably.

Thus, an improved adhesion of particles to the working roll within the meaning of the invention can be achieved by this alone or can be improved cumulatively. Furthermore, this can also lead to improved layer quality of the wear protection layer.

Furthermore, it is advantageous if, for the extraction of overspray, at least one extraction opening of an extraction device is arranged at a distance of greater than or equal to 0.1 m, preferably greater than or equal to 0.2 m, and/or at a distance of less than or equal to 1.5 m, preferably less than or equal to 1 m and preferably less than or equal to 0.5 m, from the working roll.

The distances suggested here allow overspray to be safely removed from the working roll and its surroundings.

In this case, the at least one suction opening is preferably arranged on a side of the working roll facing away from the discharge nozzle, so that particles which flow past the working roll or bounce off it can be sucked directly from the surroundings of the working roll.

Cumulatively or alternatively, other or additional positions for arranging the at least one suction opening or several suction openings may also be provided.

It is advisable to adjust the distance between the working roll and the suction opening depending on the suction speed.

This can prevent or at least significantly reduce the risk of negative air movements or air turbulence in the immediate vicinity of the working roll.

The extraction speed or the extraction distance can also cause additional cooling effects with respect to the working roll, for example through an air flow generated by the extraction, which can flow along the surface of the working roll, in particular its main part or wear protection layer.

In particular, the distance between the suction openings and the working roll can also be positioned depending on the available suction power in order to be able to additionally manipulate the temperature during the thermal application of particles.

For example, the adhesion of particles can be positively influenced if the suction speed and/or the distance between the main part and the suction opening are adjusted depending on the exit speed of the particles at or behind an exit nozzle of an application device.

This can also influence the coating temperature.

Only by means of the suction described here can an advantageous adhesion of particles on the working roll in accordance with the invention be achieved or cumulatively improved as proposed here.

This also allows the method to be operated more efficiently.

In addition, it is advantageous if, with regard to a particle mixture having hard phase particles and matrix particles, a hard phase proportion of greater than or equal to 50% is set, preferably greater than or equal to 55% and particularly preferably greater than or equal to 60%, and/or a hard phase proportion of less than or equal to 90%, preferably less than or equal to 85% and particularly preferably less than or equal to 80%.

TABLE 2
Ratio of hard phase content in the particle mixture, i.e., also the ratio of hard phase to the total layer system consisting
of hard phase and matrix: hardness, roughness Rₐ, density, homogeneity of element distribution, homogeneity of layer
thickness distribution, number of peaks, adhesive tensile strength, residual stresses and porosity of the wear protection
layer (each rated between 0 and 10 with the individual scales between smallest possible (0) and largest possible (10)
(scale designation: k-g) as well as neutral (0) and best possible (10) (scale designation: n-b).)

| | | | | | | Peak number | | | |
|---|---|---|---|---|---|---|---|---|---|
| Hard | | | | Homogeneity | | of the wear | Adhesive | | |
| phase/matrix | | Roughness | | of element | Homogeneity | protection | tensile | Residual | |
| ratio | Hardness | Rₐ | Density | distribution | of thickness | layer | strength | stresses | Porosity |
| (vol %) | (k-b) | (n-g) | (n-b) | (n-b) | (n-b) | (n-g) | (n-b) | (k-g) | (k-g) |
| 40 | 1 | 10 | 8 | 10 | 10 | 6 | 10 | 10 | 1 |
| 45 | 1 | 10 | 8 | 10 | 9 | 7 | 10 | 10 | 1 |
| 50 | 2 | 10 | 7 | 9 | 9 | 8 | 9 | 9 | 2 |
| 55 | 3 | 9 | 6 | 9 | 8 | 9 | 9 | 9 | 2 |
| 60 | 4 | 9 | 6 | 8 | 7 | 9 | 9 | 8 | 2 |
| 65 | 5 | 8 | 5 | 8 | 6 | 10 | 8 | 8 | 3 |
| 70 | 6 | 7 | 5 | 7 | 5 | 10 | 8 | 8 | 3 |
| 75 | 7 | 6 | 4 | 7 | 5 | 10 | 7 | 7 | 4 |
| 80 | 8 | 6 | 4 | 7 | 5 | 9 | 7 | 7 | 5 |
| 85 | 9 | 6 | 3 | 6 | 4 | 9 | 6 | 6 | 5 |
| 90 | 10 | 4 | 3 | 6 | 4 | 8 | 6 | 5 | 6 |

In particular, such a hard phase component can advantageously influence the hardness of the wear protection layer.

In this respect, it is advantageous if the hard phase proportion in the particle mixture has a total value as mentioned above.

Further beneficial interactions in this regard can be found in the table below.

Another favorable adhesion of particles on the working roll in accordance with the invention can be achieved or cumulatively improved if the main part is preheated to a main part temperature of greater than or equal to 30° C., preferably greater than or equal to 50° C. and particularly preferably greater than or equal to 60° C., and/or to a main part temperature of less than or equal to 120° C., preferably less than or equal to 150° C. and particularly preferably less than or equal to 200° C., before application of the particles.

In particular, by means of such preheating of the main part, a favorable increase in the coating adhesion with regard to the wear protection layer on the main part of the working roll can be achieved and thus also an improved coating quality.

It was found that with a higher heated main part, an improved layer quality can be achieved.

In particular, stress states in the wear protection layer can be favorably influenced by means of a heated main part.

Furthermore, by preheating the main part, any residual moisture present in the main part, in particular adsorbed water, and/or gases adsorbed on the main part can be reduced and/or minimized.

The wear protection layer applied using the process described here is already ready for use on the working roll, although the wear protection layer can also be further processed after the actual application if required, for example using abrasive and/or subtractive manufacturing processes.

The adhesion capacity of particles can generally be improved in the sense of the invention, at least in certain areas, if, before and/or during the application of the particles to the working roll, the main part or a wear protection layer already arranged thereon is processed abrasively and/or subtractively.

In particular, this also makes it possible to easily refurbish or repair working rolls that have already been used.

It is particularly advantageous with regard to repair if a wear protection layer is removed at least partially and/or in certain areas before and/or during the application of the particles to the working roll.

This can significantly improve the adhesion of particles to a wear protection layer already present on the main part of a used working roll.

This is especially true if an old wear protection layer already arranged on the main part is machined using a subtractive working process before the particles are applied to the machined old wear protection layer.

Additional processing of the wear protection layer can be achieved if the wear protection layer is post-processed, in particular by means of an EDT process (Electrical Discharge Texturing).

Customer-specific requirements for the wear protection layer of the working roll, in particular for the texturing of the wear protection layer of the working roll, can be easily produced in conjunction with the present post-processing method.

The present application method can also be advantageously further developed if the main part is provided semi-automatically or automatically.

By means of automation in this regard, processes can be monitored even more precisely and coordinated with one another, which can have a positive effect on the adhesion of particles to the working roll.

In a semi-automated method variant, manual intervention by operating personnel may still be required during or after a method step, whereas in a fully automated method variant such manual intervention is not absolutely necessary.

The wear protection layer to be applied to the application roll according to the invention can be applied to this application roll even more precisely by means of the present application method if the main part is measured automatically and actual values are determined for this purpose, wherein in particular the determined actual values are compared with target values.

The proposed measurement can be carried out at different times in conjunction with the proposed method, in particular before, during and/or after the provision of a main part on the application device.

Furthermore, it is advantageous if at least one coating parameter is determined automatically depending on the determined actual values.

In particular, the coating parameters already explained above can be determined at least partially automatically within the meaning of the invention.

This can particularly lead to advantageous adhesion of particles on the working roll in accordance with the invention.

In conjunction with the proposed method, coating parameters can be determined at different times, in particular before, during and/or after the application of particles to a main part on the application device.

As mentioned above, adhesion of particles on the working roll can be advantageously influenced in the sense of the invention if the main part is automatically preheated depending on determined actual values, in particular to one of the main part temperatures described above.

The degree of automation can be advantageously further developed if the wear protection layer applied to the main part is automatically final-checked, in particular final-checked optically.

This allows the quality of produced working rolls to be checked more easily, quickly and reliably.

Data collected on a produced working roll can be reliably assigned to the working roll if the produced working roll is automatically marked and registered, for example by means of a barcode, an RFID chip or the like.

If a reference sample is generated automatically, the quality assurance of the current method can be further improved.

Optionally, a new wear protection layer applied to the main part is processed using a subtractive working process, in particular post-processed, in particular abrasively and/or by means of selective laser melting.

Preferably, the tips of an applied wear protection layer are broken at their tips by an abrasive method, in particular by grinding, and/or the tips of the tips of the wear protection layer are rounded by means of selective laser melting.

This can advantageously ensure that when the working roll is used, in particular when rolling a metal material, less material is removed from the wear protection layer, which increases the service life of the wear protection layer and reduces contamination of the rolled strip by the removed wear protection layer.

Furthermore, this can ensure that when rolling a coated material with the working roll, in particular a galvanized metal material, there is less transfer of the coating of the metal material to the working roll, whereby the service life of the wear protection layer and the quality of the rolled strip can be increased.

The object of the invention is achieved according to a second aspect by a working roll having a main part and a wear protection layer for rolling a metal material, in particular for rolling a metal strip, wherein the working roll is produced by a method according to one of the features described here.

By means of the roll produced according to the invention, a metal product can be mechanically treated to a higher quality, in particular its surface.

Furthermore, the working roll produced or repaired by means of the present method generally also has a longer service life.

The object of the invention, according to a third aspect, is also achieved by a roll stand for processing a metal item, such as a metal strip, having a working roll according to one of the features described here.

Because the roll stand is equipped with the existing working roll, setup work can be further reduced and setup intervals can be further extended.

This is particularly due to the fact that the working roll has an increased service life and can therefore be used on the roll stand for a longer period of time.

The object of the invention, according to a fourth aspect, is also achieved by a metal strip, wherein the metal strip with the present working roll is rolled, in particular cold rolled.

Advantageously, the surface image obtained on the metal strip can be used to identify certain features of the wear protection layer.

In particular, the texturing of the wear protection layer of the working roll can be transferred from the surface of the working roll, in particular the surface of the wear protection layer, to the surface of the metal strip during rolling of a metal strip.

By processing the metal strip with this working roll, a very high-quality metal strip can be produced.

According to a fifth aspect of the invention, the object is achieved by an application device for applying particles to a main part of a working roll, in particular a thermal application device, having a burner device, in particular an HVOF burner (High-Velocity Oxygen Fuel burner) and/or an HVAF burner (High-Velocity Air Fuel burner) and/or the like, wherein the application device is designed such that during the thermal application of the particles to the working roll, 50% or more of the particles remain on the main part and/or on an already applied wear protection layer adhered to the main part and/or on the wear protection layer.

With this application device it is possible that at least about 50% of the particles adhere to the main part or the wear protection layer thereof and are not lost.

In this respect, the application device operates particularly efficiently both in terms of the production and repair of a working roll or a wear protection layer therefor.

It is particularly advantageous if the application device is designed so that 60% or more of the particles, preferably 75% or more and particularly preferably 80% or more of the particles, remain on the main part and/or on an already applied wear protection layer adhered to the main part and/or to the wear protection layer.

This allows the application device to be operated particularly efficiently.

In particular, such an application device can significantly improve a method for applying particles to a main part for producing a wear protection layer of a working roll or for repairing such a wear protection layer.

Preferably, the application device is designed such that during the thermal application of the particles to the working roll, 40% or less of the particles rebound from the main part and/or from an already applied wear protection layer, preferably 25% or less and particularly preferably 20% or less, so that the present application device can operate extremely efficiently. In particular, a particularly resource-efficient method can be achieved in this way.

The efficiency described here can be advantageously achieved with the present application device if the application device has a detection device for detecting a residual moisture of a particle mixture having hard phase particles and matrix particles, wherein the detection device has one or more sensor elements.

The particles can advantageously be examined at the application device with regard to their residual moisture by means of the detection device of the application device if at least one sensor element thereof is arranged on a provision device for providing the particle mixture.

A provision device in this regard can be advantageously implemented if the provision device comprises a powder conveyor, a powder mixer or the like.

Cumulatively or alternatively, it is advantageous if the application device has a screening device for screening the particles with regard to their particle size, wherein the screening device has one or more screening elements.

For example, different particles can be pre-screened on the application device using several screening elements simultaneously, or even serially, in particular according to different particle sizes and depending on a particle material.

By means of the screening device, particles can be pre-screened as required and made available to the application device.

It is understood that suitable screening devices can be designed in different ways and can be provided on the application device.

The screening device can be implemented in a structurally simple and compact manner on the application device if the screening device is arranged on a provision device for providing the particles, such as a powder conveyor, a powder mixer or the like.

The efficiency of the present application device can also be advantageously achieved or increased by means of the screening device described here.

The application device can further be advantageously designed if the application device has a further detection device for detecting particle sizes, wherein the detection device has one or more sensor elements.

Also by means of the additional detection device the application device the efficiency of the present application device can be advantageously achieved or further increased.

The sensor element(s) can also be implemented and positioned differently on the application device.

An advantageous embodiment provides that at least one sensor element of the further detection device is arranged on a provision device for providing the particles, wherein the provision device can comprise a powder conveyor, a powder mixer or the like.

In addition, the efficiency of the application device according to the invention can also be achieved or further increased if the application device has a measuring device for measuring an exit speed of the particles at an exit nozzle, wherein the measuring device has one or more sensor elements.

Advantageously, one or more sensor elements are designed to measure the exit speed at or behind the outlet nozzle.

For this purpose, one or more sensor elements can be arranged on or behind the outlet nozzle.

Furthermore, it is expedient if the application device has a further measuring device for measuring an exit temperature of the particles at an outlet nozzle, wherein the further measuring device has one or more sensor elements.

This also allows the efficiency of the application device in accordance with the invention to be achieved to a good extent or increased further.

In addition, the exit temperature can be measured reliably if one or more sensor elements are designed to measure the exit temperature at or behind the outlet nozzle.

For this purpose, at least one sensor element can be arranged on or behind the outlet nozzle.

An efficiency to be achieved in the sense of the invention can also be achieved if the application device has a suction device for sucking off overspray having at least particles not adhering to the main part, process gases, combustion products or the like from the environment of the main part, wherein the suction device has one or more.

Such a suction device can be designed and arranged differently on the application device.

Advantageously, the suction device can be adjusted to the particles to be processed if the suction elements can be flexibly positioned relative to the working roll.

In this respect, it is expedient if the suction elements or their suction openings are adjustable with regard to their respective position relative to the working roll.

In this respect, it is particularly expedient if the suction device has another detection device for detecting the position of one or more suction elements relative to the working roll.

Excess overspray can be removed particularly effectively from the area surrounding the working roll if the one or more suction elements are arranged on the side facing away from the application roll at a discharge nozzle of the application device.

The advantageous efficiency can be achieved cumulatively or alternatively with the present application device if the application device has a mixing device for mixing the particles with regard to hard phase particles and matrix particles, wherein the mixing device has an additional measuring device for measuring hard phase and/or matrix components, wherein the additional measuring device has one or more sensor elements.

The further measuring device of the application device can advantageously be arranged on the mixing device and/or on a provision device for providing the particles, such as a powder conveyor or the like.

It is also advantageous if the application device has an abrasively or subtractively operating processing device by means of which the main part and/or the wear protection layer can be processed, in particular before and/or after application of the wear protection layer.

The efficiency of the present application device can also be advantageously achieved or increased by equipping the application device with an abrasively and/or subtractively operating processing device, as this allows the main part or an existing wear protection layer to be better prepared for the application of particles.

Furthermore, a new wear protection layer applied to the main part can be post-processed by means of the subtractively operating processing device, in particular with the abrasively subtractively operating processing device and/or with the subtractively operating processing device having a device for selective laser melting.

A high degree of automation can be achieved with the present application device and thus a high level of efficiency can be ensured if the application device has a feed device for feeding the main part to a processing position, a rotation device for rotating the main part at the processing position and/or a removal device for removing the working roll from the processing position, wherein the feed device, the rotation device and the removal device work together semi-automatically or preferably fully automatically.

It is also advantageous if the application device has a cooling and/or cleaning device, wherein the cooling and/or cleaning device has one or more nozzle elements with nozzle openings.

Due to the cooling and/or cleaning effects on the application roll that can be achieved in this way, the efficiency in terms of adhesion can be significantly improved.

Advantageously, one or more nozzle elements with their nozzle openings can be adjusted with regard to their position relative to the working roll, so that, for example, different cooling effects can be achieved on the working roll, for example depending on the exit temperature of a hot gas stream carrying the particles.

For example, the cooling or cleaning device is equipped with two to four nozzle elements, which can also be positioned differently in the space opposite the working roll using a manipulator.

It is advantageous if a distance between the working roll and a nozzle element or a nozzle opening thereof is greater than or equal to 2 mm, preferably greater than or equal to 5 mm and particularly preferably greater than or equal to 10 mm, and/or a distance of less than or equal to 250 mm, preferably less than or equal to 150 mm and particularly preferably less than or equal to 100 mm.

Such distances can also be adjusted in particular depending on the properties of the main part of the corresponding working roll, such as the size, the mass or the like.

By means of different distances, additional cooling effects can also be set with regard to the working roll, for example by means of an air flow that acts more or less strongly on the working roll and can flow along the surface of the working roll, in particular with regard to its main part or wear protection layer.

In particular, the distance between the nozzle openings and the working roll can also be positioned depending on the available cooling power in order to be able to additionally manipulate the temperature during the thermal application of particles.

As a rule, distances between 15 mm and 50 mm have proven to be very suitable for the vast majority of applications.

Smaller distances have a greater impact on particle deflection, while larger distances generally result in a greater reduction in cooling effects on the working roll.

In particular, a cooling option has proven to be advantageous in this case, especially with regard to smaller working rolls, since these heat up to critical levels more quickly during a thermal spraying process than large working rolls.

If a working roll can be adequately cooled, the risk of an application process having to be interrupted due to overheating of the working roll can be reduced.

Overall, a more consistent process control can be achieved by means of good cooling of the working roll, which in turn leads to a higher quality layer structure of the wear protection layer.

In general, interruptions reduce the economic efficiency of the present method.

Different media can be used as cleaning agents and especially as cooling agents. However, especially with regard to smaller working rolls, CO₂ has proven to be very beneficial.

In any case, by means of the cooling and/or cleaning device and by means of further process variants made possible thereby with regard to cleaning of the main part and/or a possibly abrasively pre-treated wear protection layer, the adhesion capacity of particles to the working roll and thus also the efficiency of the present method or the present application device can be advantageously improved.

The situation is similar with regard to cooling the main part by means of the cooling and/or cleaning device. If the working roll can be cooled in conjunction with the present method, this can also reduce the adhesion of particles to the working roll and thus also the efficiency of the present method or the present application device can be advantageously improved.

In order to ensure a uniform supply of particles to the application device, it is advantageous if the application device has a provision device for providing particles, wherein the provision device is designed to supply the particles with a supply tolerance of +/−2 g per minute with regard to a supply quantity.

As already mentioned above, it is advantageous if the application device has one or more provision devices on which different detection and/or measuring devices or the like can also be arranged.

In order to ensure that a uniform quantity of particles can be made available for thermal application or spraying, particularly at the outlet nozzle of the application device, it is imperative that the particles are also conveyed reliably.

In this context, a conveying tolerance of a maximum of +/−2 g per minute has proven advantageous in order to be able to produce a particularly uniform wear protection layer on the working roll.

The conveying tolerance can vary upwards or downwards depending on the amount of particles to be conveyed.

In particular, the provision device can be designed in the form of a correspondingly designed powder conveyor for conveying the powdery particle mixture.

It is understood that the individual devices of the application device, such as in particular the detection devices, the measuring devices, the cooling and/or cleaning device and/or the screening device, etc., can be adjusted in particular manually to the respective working roll.

However, it is advantageous if the relevant devices can be adjusted automatically, for example based on method parameters, such as data on the main part and/or the wear protection layer.

Furthermore, it is advantageous if the provision device, in particular a powder conveyor, is designed to use the thermal energy generated at the application device (e.g. HVOF burner or HVAF burner) to preheat the particles or the particle mixture to be conveyed.

For example, by means of such preheating of the particles, the melting behavior or melt liquefaction of the particles in the hot gas stream can be influenced.

At this point, it should also be mentioned that it is advantageous if the heat energy generated by the application device is also used cumulatively to reduce the residual moisture in the particle mixture.

It is also advantageous if the heat energy generated by the application device is also used cumulatively to preheat a main part of the working roll.

However, a preferred embodiment provides that the present application device has an open-loop and/or closed-loop control device, wherein the open-loop and/or closed-loop control device is designed to automatically provide open-loop and/or closed-loop control of one or more devices of the application device, in particular also in dependence on one another.

By means of such an open-loop and/or closed-loop control device, the operation of one or more devices can be controlled automatically, which can also have a further positive effect on the adhesion properties.

In this respect, it is advantageous if the open-loop and/or closed-loop control device operates as a function of, in particular, at least one of the detection devices, of at least one of the measuring devices, of the cooling and/or cleaning device, screening device and/or other provision devices, the delivery device, the rotation device and/or the removal device, etc., in particular of data determined therefrom.

Obviously, the efficiency of the present application device can be increased by means of the appropriately designed open-loop and/or closed-loop control device can be advantageously achieved or even increased.

It is particularly useful if the open-loop and/or closed-loop control device is designed so that during the thermal application of the particles to the working roll, 50% or more of the particles remain on the main part and/or on an already applied wear protection layer adhered to the main part and/or on the wear protection layer.

It is particularly advantageous if the open-loop and/or closed-loop control device is designed so that 60% or more of the particles, preferably 75% or more and particularly preferably 80% or more of the particles, remain on the main part and/or on an already applied wear protection layer adhered to the main part and/or on the wear protection layer.

The application device can operate particularly efficiently if the open-loop and/or closed-loop control device is designed to ensure that 40% or less of the particles bounce off the main part and/or an already applied wear protection layer during the thermal application of the particles to the working roll, preferably 25% or less and particularly preferably 20% or less.

In this respect, the open-loop and/or closed-loop control device for providing open-loop and/or closed-loop control of the application device, in particular for carrying out a method according to one of the features described here, is advantageous.

In particular, the method according to the invention can be carried out particularly efficiently by an application device operating in this way.

A further advantageous increase in efficiency with regard to improved adhesion of particles to the working roll can also be achieved by the selection of the dimensions (measurements) of the working roll, the mass of the working roll, the main part material and/or the production method of the main part.

Preferably, the application device has a layer thickness check which is set up to measure a layer thickness of the wear protection layer, in particular a real-time layer thickness check, in particular a permanently running layer thickness check.

In this way, the application device can be advantageously open-loop and/or closed-loop controlled in order to achieve a desired layer thickness of the wear protection layer.

Further advantages, details, and features of the invention can additionally be found in the exemplary embodiment described below.

In the drawing:

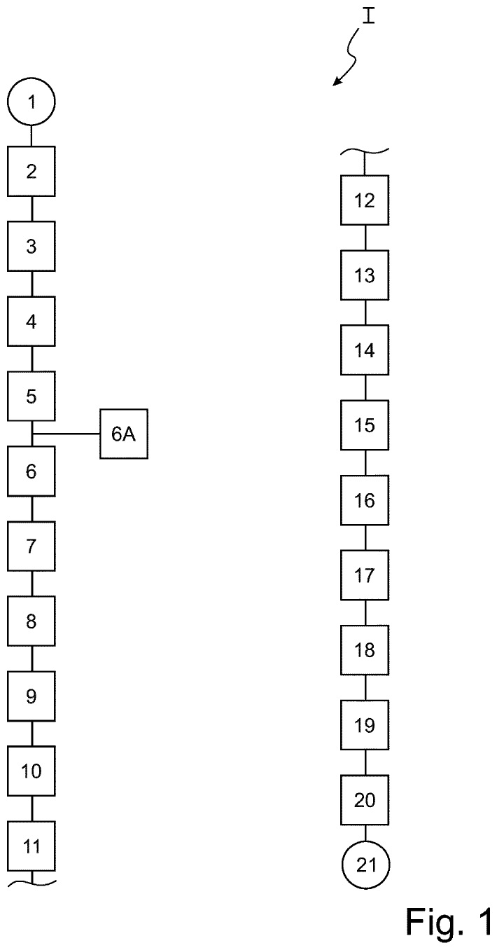

FIG. 1: schematically shows a view of a possible method sequence for producing or repairing a working roll with regard to a plurality of method options, several of which are optional; and

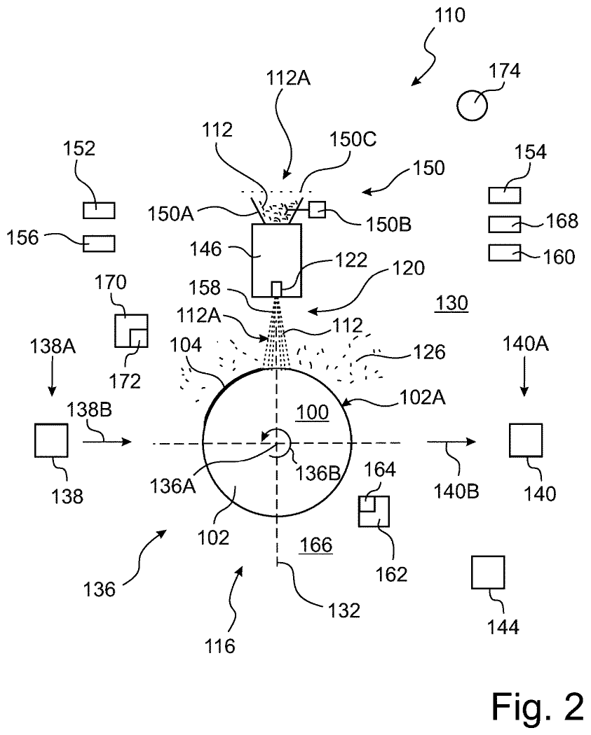

FIG. 2: schematically shows a view of an application device for applying particles to a working roll, by means of which the method or the method sequence from FIG. 1 can be carried out.

According to the illustration in FIG. 1, a first possible method sequence I of a method for the automated production or repair of a working roll 100 (see FIG. 2) is shown as an example for rolling a metal product (not shown).

At this point it should be mentioned that modifications of the method are not shown or described again separately using other representations of method sequences.

In this respect, individual method steps can be changed in terms of their order or combined with one another.

It is also understood that individual method steps may, on the one hand, be optional, and, on the other hand, the method sequence shown only as an example may be supplemented by further method steps or modifications thereof not explicitly shown here.

The exemplary method shown in the illustration according to FIG. 1 begins at a starting point 1 with a first method step 1, which comprises the provision of a main part 102 of the working roll 100.

This can be a working roll 100 to be newly produced with a still unused main part 102 or a working roll 100 to be repaired with a used main part 2 already provided with a used wear protection layer 104.

In any case, the working roll 100 can be applied at the starting point 1 in an automated manner, i.e., without manual intervention by operating personnel, to an application device 110 (see FIG. 2) for thermally applying or spraying particles 112 onto the surface 104 of the working roll 100.

With the method sequence shown and explained here, 65% or more of the particles 112 sprayed in the direction of the working roll 100 will adhere to the working roll 100, whereby the method can be operated extremely efficiently.

After the main part 102 has been provided or supplied to a processing position 116 of the application device 110, the main part 102 is cleaned according to a method step 2.

According to a method step 3, the main part 102 is measured in order to determine actual values of the main part 102 and of any old wear protection layer 104 already present thereon.

According to method step 4, determined actual values can be automatically compared with target values.

According to a method step 5, processing and coating parameters can then be determined automatically depending on the actual values determined.

According to a method step 6, the main part 102 can be preheated automatically, if necessary, for example to 110° C.

If it is a working roll 100 to be repaired, according to an intermediate method step 6A, the existing old wear protection layer 104 can first be treated, in particular automatically, with abrasives, for example in order to carry out a partial layer removal in an automated manner, so that the old wear protection layer 104 as a whole is automatically equalized and automatically processed, or if necessary is automatically completely removed from the main part 102.

Thereafter, the correspondingly machined main part 102 can be preheated as required according to method step 6.

According to method step 7, residual moisture is automatically measured and, if necessary, automatically reduced to a value of 7%.

According to a method step 8, the particles 112 can already be preheated automatically.

According to a method step 9, the particles 112 are automatically pre-screened so that different particles have a particle size between 10 μm and 25 μm.

According to a method step 10, the particles 112 are automatically mixed to form a desired particle mixture 112A consisting in particular of hard phase particles and matrix particles, wherein the hard phase proportion is 65%.

According to a method step 11, the particle mixture 112A is automatically preheated to a use temperature, which can be set, for example, to approximately 60° C.

According to a method step 12, the particles 112 are automatically thermally applied or sprayed as a particle mixture 112A onto the working roll 100 rotating in the processing position 116, for example with an adhesion capacity of more than 65%.

According to a method step 13, the exit speed of the particle mixture 112A, which exits in a hot gas stream 120 from an exit nozzle 122 of the application device 110, is automatically measured and, if necessary, automatically adjusted, for example to approximately 1050 m/s.

According to a method step 14, the exit temperature of the particle mixture 112A is automatically measured and, if necessary, automatically adjusted, for example to approximately 900° C.

According to a method step 15, an overspray 126 is automatically sucked away from the surroundings 130 of the working roll 100, preferably at a suction speed of 22 m/s.

According to a method step 16, the working roll 100 is cooled automatically.

According to a method step 17, the wear protection layer 104 is automatically post-processed, for example by means of an EDT method.

According to a method step 18, the wear protection layer 104 is automatically final-checked, for example optically.

According to a method step 19, the produced working roll 100 is automatically marked and registered.

According to a method step 20, a reference sample is generated automatically.

According to a method step 21, the produced working roll 100 is automatically removed from the processing position and made available for further use.

In this respect, the method sequence explained by way of example, which began at starting point 1, ends with method step 21, which represents the end point 21 of the method sequence.

Now the method sequence can start again at the starting point 1, wherein the method sequence can be carried out in the same or modified way.

As already mentioned above, individual method steps can be combined in almost any way, carried out multiple times or optionally, or omitted.

According to the illustration in FIG. 2, a first possible embodiment of an application device 110 for applying particles 112 as particle mixture 112A to the surface 102A of the main part 102 of the working roll 100 is shown.

The application device 110 has a machine direction 132, in the direction of which the particle mixture 112A is applied to the working roll 100.

The application device 110 has a processing position 116, at which the working roll 100 for the thermal application of the particles 112 is arranged with a rotation device 136 rotatably mounted about a rotation axis 136A. According to the illustration in FIG. 2, a direction of rotation 136B is shown.

The application device 110 has a feed device 138 (shown only schematically) with a feed position 138A, from which the main part 102 of the designated working roll 100 is fed into the processing position 116 with a feed direction 138B.

The application device 110 further has a removal device 140 (shown only schematically) with a removal position 140A, into which the produced working roll 100 is removed from the processing position 116 with a removal direction 140B.

In this exemplary embodiment, the application device 110 also comprises an abrasively and/or subtractively operating processing device 144 (shown only schematically), by means of which the main part 102 and/or the wear protection layer 104 can be processed as required.

To generate the hot gas stream 120, the application device 110 has a burner device 146, wherein the particles 112 are carried out of the outlet nozzle 122 of the application device 110 in the machine direction 132 by means of the hot gas stream 120.

The burner device 146 can be designed in different ways, for example as an HVOF burner.

In order that the particles 112 or the powdered particle mixture 112A can be reliably supplied to the burner device 146 and sufficiently provided there, the application device 110 has a provision device 150.

The provision device 150 is positioned in an operative relationship with the burner device 146, in particular above the burner device 146, and has in particular a powder conveying device 150A for conveying the particles 112 or the particle mixture 112A, a mixing device 150B for mixing the particles 112 or the particle mixture 112A, and a screening device 150C for screening the particles 112 or the particle mixture 112A.

In order to be able to set the most optimal residual moisture possible with regard to the particles 112 or the powdered particle mixture 112A, and specifically before the particles 112 are fed to the burner device 146 or the outlet nozzle 122 thereof, the application device 110 has a first detection device 152, the sensor elements (not shown here) of which can detect the residual moisture of the particles 112 or the powdered particle mixture 112A.

The sensor elements are provided on the provision device 150.

Increased residual moisture can be reduced as needed by means of the heat energy generated by the burner device 146.

In particular, functions of the application device 110 can be manipulated in accordance with the invention by means of determined residual moisture values.

In order to be able to determine the particle size of the particles 112 or the powdered particle mixture 112A on the application device 110, the application device 110 has a further detection device 154, the sensor elements of which (not shown here) can detect the particle size with regard to the particles 112 or the powdered particle mixture 112A.

In particular, functions of the application device 110 can be manipulated in accordance with the invention by means of determined particle size values.

In order to be able to measure an exit speed of the particles 112 at the exit nozzle 122, the application device 110 also has a measuring device 156 for measuring an exit speed.

For this purpose, the measuring device 156 has one or more sensor elements (not shown) by means of which the exit speed can be measured in an area 158 on or behind the outlet nozzle 122.

In particular, functions of the application device 110 can also be manipulated in accordance with the invention by means of determined exit speed values.

In order to also be able to measure an exit temperature of the particles 112 or the hot gas stream 120 at the outlet nozzle 122, the application device 110 has a further measuring device 160 for measuring an exit temperature.

The measuring device 160 also has one or more sensor elements (not shown) by means of which the exit temperature can be measured in an area 158 on or behind the outlet nozzle 122.

In particular, functions of the application device 110 can also be manipulated in accordance with the invention by means of determined exit temperature values.

In addition, the application device 110 also has a suction device 162 comprising one or preferably several suction elements (not explicitly shown here) with suction openings (not explicitly shown here), by means of which an overspray 126 can be sucked out of the surroundings 130 of the working roll 100 or in particular from the processing position 116.

The suction device 162 or suction elements thereof are adjustable in their position relative to the working roll 100 and thus also relative to a rotation axis 136A.

For this purpose, the application device 110 or the suction device 162 has another detection device 164 by means of which this position can be detected.

Overspray 126 can be kept away from the working roll 100 in a particularly advantageous manner if the suction device 162 or suction elements thereof are arranged on a side 166 facing away from the outlet nozzle 122.

In addition, functions of the application device 110 can be additionally manipulated in accordance with the invention by means of determined position values.

Cumulatively, functions of the application device 110 can be conveniently manipulated if the application device 110 or the mixing device 150B already described above has an additional measuring device 168 for measuring hard phase and/or matrix components.

For this purpose, the additional measuring device 168 has one or more sensor elements (not explicitly shown), which are preferably arranged on the provision device 150.

Furthermore, the application device 110 also has a cooling and/or cleaning device 170, by means of which the working roll 100 or the main part 102 or the wear protection layer 104 can be cooled or cleaned as required.

For this purpose, the cooling and/or cleaning device 170 has nozzle elements (not shown in detail) with nozzle openings which are adjustable with regard to their position relative to the working roll 100.

The respective position can be determined by means of an observation device 172.

In particular, functions of the application device 110 can be favorably manipulated in accordance with the invention by means of determined position values.

In order to better coordinate the evaluation and open-loop or closed-loop control of the individual functions of the application device 110, the application device 110 also has a higher-level open-loop and/or closed-loop control device 174.

At this point it should be mentioned that all electrical, data or other connecting lines, as well as interfaces, etc., are not explicitly shown for the sake of clarity.

In any case, the application device 110 shown and explained here makes it possible for 65% or more of the particles 112 sprayed in the direction of the working roll 100 to adhere to the working roll 100, whereby the application device 110 and the method carried out therewith can be operated extremely efficiently.

### LIST OF REFERENCE SIGNS

I method sequence
1 starting point or first method step (provision)
2 a second method step (cleaning)
3 a third method step (measuring)
4 a fourth method step (comparing values)
5 a fifth method step (determining processing parameters)
6 a sixth method step (preheating main part)
6A an alternative sixth method step (abrasive treatment)
7 a seventh method step (reducing residual moisture)
8 an eighth method step (preheating particles)
9 a ninth method step (pre-screening)
10 a tenth method step (mixing)
11 an eleventh method step (preheating particle mixture)
12 a twelfth method step (thermal application)
13 a thirteenth method step (determining exit speed)
14 a fourteenth method step (determining exit temperature)
15 a fifteenth method step (overspray extraction)
16 a sixteenth method step (cooling working roll)
17 a seventeenth method step (post-processing)
18 an eighteenth method step (final checking)
19 a nineteenth method step (registration)
20 a twentieth method step (reference sample)
21 a twenty-first method step (removal)
100 working roll
102 main part (new or used)
102A surface
104 wear protection layer
110 application device
112 particle
112A particle mixture
116 processing position
120 hot gas stream
122 outlet nozzle
126 overspray
130 environment
132 machine direction
136 rotation device
136A axis of rotation
136B direction of rotation
138 feed device
138A feed position
138B feed direction
140 removal device
140A removal position
140B removal direction
144 processing device
146 burner device
150 provisioning device
150A powder conveyor
150B mixing device
150C screening device
152 detection device
154 further detection device
156 first measuring device
158 region
160 further measuring device
162 extraction device
164 other detection device
166 side facing away
168 additional measuring device
170 cooling and/or cleaning device
172 observation device
174 open-loop and/or closed-loop control device

1. A method for producing or repairing a working roll having a main part and a wear protection layer, in which particles are thermally applied to the working roll, characterized in that during the thermal application of the particles, 50% or more of the particles preferably 60% or more, or 75% or more, and particularly preferably 80% or more of the particles, remain on the main part and/or on an already applied wear protection layer adhered to the main part and/or on the wear protection layer, wherein
the main part is preheated to a main part temperature of greater than or equal to 30° C. preferably greater than or equal to 50° C. and particularly preferably greater than or equal to 60° C., before the particles are applied, and wherein
a particle mixture having hard phase particles and matrix particles has a residual moisture of less than or equal to 10%, preferably less than or equal to 5%, particularly preferably less than or equal to 2%.

2. The method according to claim 1, characterized in that during the thermal application of the particles, 50% or less of the particles rebound from the main part and/or from an already applied wear protection layer.

3. The method according to claim 1, characterized in that the particles have a particle size of greater than or equal to 0.5 μm.

4. The method according to claim 1, characterized in that the particles are pre-screened to a particle size of less than or equal to 60 μm.

5. The method according to claim 4, characterized in that the particles are pre-screened on an application device, before being added to a hot gas stream of the application device.

6. The method according to claim 1, characterized in that the particles at or behind an outlet nozzle of an application device have an exit speed of greater than or equal to 500 m/s and/or an exit speed of less than or equal to 1500 m/s.

7. The method according to claim 6, characterized in that the exit speed is measured at a location or at a region which is arranged at a distance of 100 mm or less from the exit nozzle.

8. The method according to claim 1, characterized in that the particles are discharged from an outlet nozzle of an application device by means of a hot gas stream, wherein the particles and/or the hot gas stream have an exit temperature of greater than or equal to 800° C. and/or the particles and/or the hot gas stream have an exit temperature of less than or equal to 2200° C.

9. The method according to claim 8, characterized in that the exit temperature is adjusted depending on properties of the particles.

10. The method according to claim 8, characterized in that the exit temperature is measured at a location or at a region which is arranged at a distance of 100 mm or less from the outlet nozzle.

11. The method according to claim 1, characterized in that during the application of particles to the working roll, an overspray surrounding the working roll having at least particles not adhering to the main part, process gases, combustion products or the like is sucked off from the environment of the working roll at a suction speed of greater than or equal to 10 m/s.

12. The method according to claim 11, characterized in that, for the extraction of overspray, at least one extraction opening of an extraction device is arranged at a distance of greater than or equal to 0.1 m from the working roll.

13. The method according to claim 11, characterized in that the distance between the working roll and the suction opening is adjusted depending on the suction speed.

14. The method according to claim 11, characterized in that the suction speed and/or the distance between the main part and the suction opening are adjusted as a function of an exit speed of the particles at or behind an exit nozzle of an application device.

15. The method according to claim 1, characterized in that with regard to a particle mixture having hard phase particles and matrix particles, a hard phase proportion of greater than or equal to 50% is set and/or a hard phase proportion of less than or equal to 90%.

16. The method according to claim 1, characterized in that the main part is preheated to a main part temperature of less than or equal to 120° C. before the particles are applied.

17. The method according to claim 1, characterized in that before applying and/or during applying the particles to the working roll, the main part or a wear protection layer already arranged thereon is processed abrasively and/or subtractively.

18. The method according to claim 17, characterized in that a wear protection layer is removed at least partially and/or in certain areas before and/or during the application of the particles to the working roll.

19. The method according to claim 17, characterized in that an old wear protection layer already arranged on the main part is processed using a subtractive working method before the particles are applied to the processed old wear protection layer.

20. The method according to claim 1, characterized in that the wear protection layer is post-processed by means of an EDT process (Electrical Discharge Texturing).

21. The method according to claim 1, characterized in that the main part is provided semi-automatically or automatically on an application device.

22. The method according to claim 21, characterized in that the main part is measured automatically and actual values are determined for this purpose, wherein the determined actual values are compared with target values.

23. The method according to claim 21, characterized in that at least one coating parameter is determined automatically depending on the actual values determined.

24. The method according to claim 21, characterized in that the main part is automatically preheated depending on determined actual values.

25. The method according to claim 21, characterized in that the wear protection layer applied to the main part is automatically final-checked.

26. The method according to claim 21, characterized in that the produced working roll is automatically marked and registered.

27. The method according to claim 21, characterized in that a reference sample is automatically produced.

28. The method according to claim 1, characterized in that a new wear protection layer applied to the main part is processed using a subtractive working method.

29. An application device for applying particles to a main part of a working roll, having a burner device for carrying out a method according to claim 1, characterized in that the application device has a detection device for detecting a residual moisture of a particle mixture having hard phase particles and matrix particles, wherein the detection device has one or more sensor elements which are arranged in particular on a provision device for providing the particle mixture, and in that the application device is designed such that during the thermal application of the particles to the working roll, 50% or more of the particles remain on the main part and/or on an already applied wear protection layer adhered to the main part and/or on the wear protection layer.

30. The application device according to claim 29, characterized in that the application device is designed such that 60% or more of the particles remain on the main part and/or on an already applied wear protection layer adhered to the main part and/or on the wear protection layer.

31. The application device according to claim 29, characterized in that the application device is designed such that during the thermal application of the particles to the working roll, 40% or less of the particles bounce off the main part and/or off an already applied wear protection layer.

32. The application device according to claim 29, characterized in that the application device has a screening device for screening the particles with regard to their particle size, wherein the screening device has one or more screening elements which are arranged in particular on a provision device for providing the particles.

33. The application device according to claim 29, characterized in that the application device has a further detection device for detecting particle sizes, wherein the further detection device has one or more sensor elements which are arranged on a provision device for providing the particles.

34. The application device according to claim 29, characterized in that the application device has a measuring device for measuring an exit speed of the particles at an exit nozzle, wherein the measuring device has one or more sensor elements by means of which the exit speed at or behind the exit nozzle can be measured.

35. The application device according to claim 29, characterized in that the application device has a further measuring device for measuring an exit temperature of the particles at an outlet nozzle, wherein the further measuring device has one or more sensor elements by means of which the exit temperature at or behind the outlet nozzle can be measured.

36. The application device according to claim 29, characterized in that the application device has a suction device for suctioning off overspray having at least particles not adhering to the main part, process gases, combustion products or the like from the environment of the main part, wherein the suction device has one or more suction elements with suction openings which are adjustable in particular with regard to their position relative to the working roll.

37. The application device according to claim 36, characterized in that the suction device has another detection device for detecting positions of one or more suction elements relative to the working roll.

38. The application device according to claim 36, characterized in that the one or more suction elements are arranged on the side facing away from the application roll at an outlet nozzle of the application device.

39. The application device according to claim 29, characterized in that the application device has a mixing device for mixing the particles with regard to hard phase particles and matrix particles, wherein the mixing device has an additional measuring device for measuring hard phase and/or matrix components, wherein the additional measuring device has one or more sensor elements which are arranged in particular on the mixing device and/or on a provision device for providing the particles, such as a powder conveyor or the like.

40. The application device according to claim 29, characterized in that the application device has an abrasively or subtractively operating processing device by means of which the main part and/or the wear protection layer can be processed.

41. The application device according to claim 29, characterized in that the application device has a feed device for feeding the main part to a processing position, a rotation device for rotating the main part at the processing position and/or a removal device for removing the working roll from the processing position, wherein the feed device, the rotation device and the removal device work together semi-automatically or preferably fully automatically.

42. The application device according to claim 29, characterized in that the application device has a cooling and/or cleaning device, wherein the cooling and/or cleaning device has one or more nozzle elements with nozzle openings which are adjustable in particular with regard to their position relative to the working roll.

43. The application device according to claim 29, characterized in that the application device has a provision device for providing particles, wherein the provision device is designed to supply the particles with a supply tolerance of +/−2 g/min with respect to a supply quantity.

44. The application device according to claim 29, characterized by an open-loop and/or closed-loop control device, wherein the open-loop and/or closed-loop control device is designed to automatically provide open-loop and/or closed-loop control of one or more of the devices of the application device, in particular also in dependence on one another.

45. The application device according to claim 29, characterized in that the application device has a layer thickness check which is set up to measure a layer thickness of the wear protection layer.
